(19) United States
(12) Patent Application Publication
(10) Pub. No.: US 2025/0349848 A1
(43) Pub. Date: Nov. 13, 2025

(54) NEW NASICON-TYPE HIGH VOLTAGE SODIUM VANADIUM PHOSPHATES MATERIALS FOR NA-ION BATTERIES

(71) Applicants: CENTRE NATIONAL DE LA RECHERCHE SCIENTIFIQUE, PARIS (FR); NATIONAL UNIVERSITY OF SINGAPORE, SINGAPORE (SG); UNIVERSITE DE PICARDIE JULES VERNE, AMIENS CEDEX 1 (FR); UNIVERSITÉ DE BORDEAUX, BORDEAUX (FR); INSTITUT POLYTECHNIQUE DE BORDEUX, TALENCE (FR); TIAMAT, AMIENS (FR)

(72) Inventors: Sunkyu PARK, TALENCE (FR); Jean- Noël CHOTARD, PARIS (FR); Laurence CROGUENNEC, SAINT-SELVE (FR); Dany CARLIER-LARREGARAY, PESSAC (FR); Christian MASQUELIER, BOVES (FR); Ziliang WANG, SINGAPORE (SG); Pieremanuele CANEPA, SINGAPOR (SG)

(21) Appl. No.: 18/861,050

(22) PCT Filed: Apr. 27, 2023
(86) PCT No.: PCT/EP2023/061161

§ 371 Date: Oct. 28, 2024

(30) Foreign Application Priority Data
Apr. 29, 2022 (EP) 22305644.1

(51) Int. Cl. H01M 4/58; H01M 4/02; H01M 4/04; H01M 10/0525; H01M 10/054

(52) U.S. Cl. CPC H01M 4/5825; H01M 4/0471; H01M 10/0525; H01M 10/054; H01M 2004/028

(57) ABSTRACT

The present invention concerns a material of formula (I):

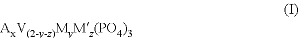

wherein:
A is Na or Li or a mixture of Na and Li,

$$\begin{matrix}1 < x < 3 , \\ 0 \leq y \leq 1 , \\ 0 \leq z \leq 1\end{matrix}$$

M is an electro-active transition element or a mixture of at least two electro-active transition elements,
M′ is a non electro-active element or a mixture of at least two non electro-active elements, and the material of formula (I) presents a V/Z ratio varying from 212 Å³ to 246 Å³.

The present invention concerns a new Na-based positive electrode active material for Na-ion batteries. The present invention also relates to a method of preparation of said material and its use as an electrode material. The present invention also relates to an electrode material comprising said Na-based material, and to a battery comprising said electrode.

### STATE OF THE ART

Lithium-ion batteries have been extensively used for electric vehicles and portable devices due to their satisfactory energy and power densities. However, lithium resources are costly and unevenly distributed over the world, making it challenging to meet the urgent demand for large-scale energy storage systems.

The most appealing alternative to Li-ion batteries regarding chemical element abundance and cost is sodium, due to the abundant and evenly distributed resources and relatively low material cost compared to lithium-ion batteries.

The performance of the Na-ion batteries is partly related to the capacity of the positive electrode material. Sodium layered transition metal oxides, prussian blue analogues, and polyanionic compounds are considered as possible positive electrode materials for sodium-ion batteries. Polyanionic compounds having the NASICON structure are potential options as a positive electrode material because of their structural stability, rate performance, and long-cycle life. Among them, Na₃V₂(PO₄)₃ has been extensively studied, delivering a theoretical capacity of 117.6 mAh/g, utilizing the V⁴⁺/V³⁺ redox couple. Two Nations can be reversibly exchanged through a biphasic mechanism between Na₃V₂(PO₄)₃ and Na₁V₂(PO₄)₃ having a voltage-composition plateau at around 3.4 V vs. Na⁺/Na during the electrochemical charge and discharge processes. Na₃V₂(PO₄)₃ undergoes moderate volume changes of about 8.2% during the said electrochemical reaction.

However, the extraction of the third Na⁺(from Na₁V₂(PO₄)₃ to V₂(PO₄)₃) does not occur in the electrochemical reaction because of large migration energy of the last Na⁺ hence contributing to the weight penalty and limited capacity. More importantly, the working voltage of Na₃V₂(PO₄)₃ is 3.4 V vs. Na⁺/Na, which is relatively low.

Therefore, there is still a need for new positive electrode materials exhibiting improved performances in comparison to positive electrode materials of the prior art.

### AIMS OF THE INVENTION

One of the aims of the present invention is to provide an electrode material, preferably a positive electrode material, presenting better performances than electrode materials of the prior art, in particular than the conventional Na₃V₂(PO₄)₃ or Li₃V₂(PO₄)₃ materials

In particular, one aim of the present invention is to provide an electrode material, preferably a positive electrode material, displaying a high operating voltage vs. Na⁺/Na or Li⁺/Li.

Another particular aim of the present invention is to provide an electrode material, preferably a positive electrode material, delivering a higher energy density than that of the conventional Na₃V₂(PO₄)₃ or Li₃V₂(PO₄)₃ materials.

Another particular aim of the present invention is to provide an electrode material, preferably a positive electrode material, having less volume expansion/contraction during electrochemical operation than that of the conventional Na₃V₂(PO₄)₃ or Li₃V₂(PO₄)₃ materials.

Another aim of the invention is to provide an electrode material showing a single-phase reaction mechanism during the charge and discharge processes.

### DETAILED DESCRIPTION OF THE INVENTION

The present invention relates to a material of formula (I):

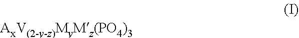

wherein:
A is Na or Li or a mixture of Na and Li,

$$\begin{matrix}1 < x < 3 , \\ 0 \leq y < 1 , \\ 0 \leq z < 1\end{matrix}$$

M is an electro-active transition element or a mixture of at least two electro-active transition elements,
M′ is a non electro-active element or a mixture of at least two non electro-active elements, and
the material of formula (I) presents a V/Z ratio (volume of the crystalline unit-cell per formula unit) varying from 212 Å³ to 246 Å³.

By transition element, it means a transition metal.

The inventors have discovered that the material of formula (I) according to the invention possesses a number of interesting physical and electrochemical properties compared to the existing positive electrode materials Na₃V₂(PO₄)₃ or Li₃V₂(PO₄)₃. For instance, in the case where A=Na, the material of formula (I) shows about two reversible Na⁺ ions exchanged within a voltage window of 2.5-4.3 V vs. Na⁺/Na, and a corresponding theoretical capacity higher than that of Na₃V₂(PO₄)₃. Moreover, the average working voltage of the material according to the invention has been increased to ca. 3.75 V vs. Na⁺/Na (from ca. 3.4 V in the conventional Na₃V₂(PO₄)₃). Also, the electrochemical reaction mechanism upon sodium extraction/insertion from/into this material occurs through a solid-solution (single phase) mechanism with a continuous increase of the operating voltage as Na⁺ is electrochemically extracted, which is different from the biphasic one encountered for “classical” Na₃V₂(PO₄)₃. This is very appreciable since it allows for more cost-effective monitoring of the state of charges than systems with a flat voltage profile. Finally, instead of the « classical » constant-voltage 3.4 V process of Na₃V₂(PO₄)₃, the operating voltages of the materials of the invention range, in a sloping manner, from 3.0 V to 4.3 V vs. Na⁺/Na. Thanks to the subsequent increase in operating voltage, the theoretical gravimetric energy density of the materials of the invention is therefore subsequently increased by about 15%, to 464 Wh/kg, when compared with conventional Na₃V₂(PO₄)₃.

Preferably, electro-active transition element M is selected from the group consisting of Ti, V, Cr, Mn, Fe, Co, Ni, Cu, Nb and Mo, more preferably from the group consisting of Ti, V, Cr, Mn, Fe and Nb.

Preferably, non electro-active element M′ is selected from the group consisting of Mg, Al, Sc, Y, Zr, Er, and Ta, more preferably from the group consisting of Mg, Al and Zr.

The non electro-active element M′ used for slight doping, especially if it is at +2 (Mg²⁺) or +3 (Al³⁺) oxidation state allows to access the V⁴⁺/V⁵⁺ redox couple at high voltage when two Na⁺ are extracted from a composition containing less than two vanadium. Thus, it allows increasing both the energy density delivered and the sustainability of the material.

When M is a mixture of at least two electro-active transition elements, y represents the sum of the molar fraction of each transition element comprised in M.

When M′ is a mixture of at least two non electro-active elements, z represents the sum of the molar fraction of each non electro-active element comprised in M′.

Preferably, 0≤y≤0.8, more preferably 0≤y≤0.5, even more preferably 0≤y≤0.2.

Preferably, 0≤z≤0.5, more preferably 0≤z≤0.2.

According to an embodiment, y=0 and/or z=0.

Preferably, x varies from 1.1 to 2.9, preferably from 1.2 to 2.8, preferably from 1.3 to 2.7, preferably from 1.4 to 2.6, preferably from 1.5 to 2.5, preferably from 1.6 to 2.4, preferably from 1.7 to 2.3, preferably from 1.8 to 2.2, preferably from 1.9 to 2.1, and/or any other suitable combination range.

Typically, x, y and z are chosen so as to ensure the electroneutrality of the material of formula (I).

According to the invention, the V/Z ratio of the material of formula (I) is the unit cell volume in Å³ per formula unit. This feature is well-known to the skilled person. The V/Z ratio is determined by fitting the powder diffraction profiles with the so-called Le Bail method for example, from X-ray or neutron diffraction patterns of the powders of the material of formula (I) according to the invention. The X-ray or neutron diffraction patterns are commonly obtained (unless specifically mentioned) at 25° C. (298 K). The V/Z ratio is independent from the space group used to represent the crystallographic structure of the material of formula (I).

Advantageously, the material of formula (I) is a single-phase material.

A single-phase material is a solid material consisting in a unique solid phase described by a crystallographic structure that gives the respective atomic positions of the formula within a so-called unit-cell described with an appropriate space group.

According to an embodiment, A=Li.

In this embodiment, the material of formula (I) preferably presents a V/Z ratio varying from 212 Å³ to 225 Å³.

According to another embodiment, A is a mixture of Li and Na. According to this embodiment, x represents the sum of the molar fraction x′ of Li element and of the molar fraction (1-x′) of Na element.

Preferably, 0≤x′≤1.

In this embodiment, the material of formula (I) preferably presents a V/Z ratio varying from 212 Å³ to 235 Å³.

According to another embodiment, A=Na.

In this embodiment, the material of formula (I) preferably presents a V/Z ratio varying from 219 Å³ to 246 Å³, preferably from 220.2 Å³ to 239.5 Å³.

Preferably, the V/Z ratio varies from 225 Å³ to 239 Å³, preferably from 230 Å³ to 239 Å³, preferably from 232 Å³ to 239 Å³, preferably from 234 Å³ to 239 Å³, preferably from 235 Å³ to 238 Å³, preferably from 236 Å³ to 237.5 Å³ and/or any other suitable combination range.

Preferably, when 1.8≤x≤2.3, the V/Z ratio varies from 232 Å³ to 239 Å³, preferably from 235 Å³ to 238 Å³.

More preferably, when x=2, the V/Z ratio varies from 232 Å³ to 239 Å³, advantageously from 235 Å³ to 238 Å³. It means that the V/Z ratio is preferably further defined with the proviso that if x=2, the V/Z ratio varies from 232 Å³ to 239 Å³, advantageously from 235 Å³ to 238 Å³.

The material of formula (I) according to the invention can be structurally described using an hexagonal unit-cell or, alternatively, a monoclinic or triclinic unit-cell depending on the global Na content and on possible Na-ion ordering within the framework that generates slight distortions. Preferably, the material of formula (I) is described with a hexagonal unit-cell, more symmetrical than the monoclinic or triclinic descriptions.

Preferably, the material of formula (I) has a lattice with a global symmetry to be described in the R32, R-3, R-3c, C2/c, P-1 or P-3 space groups.

More preferably, the material of formula (I) is structurally described with a hexagonal unit-cell and a R-3c space group.

Preferably, when described with a hexagonal unit-cell, the material of formula (I) with A=Na has the following lattice parameters:
a_{hexagonal} is between 8.60 and 8.72 Å, preferably between 8.64 and 8.68 Å, more preferably substantially equal to 8.654 Å, and
c_{hexagonal} is between 21.80 and 21.94 Å, preferably between 21.88 and 21.94 Å, more preferably substantially equal to 21.896 Å.

Preferably, the c/a ratio varies from 2.500 to 2.550, more preferably from 2.505 to 2.545, more preferably from 2.510 to 2.545, more preferably from 2.515 to 2.540, more preferably from 2.520 to 2.538, more preferably from 2.525 to 2.536, more preferably from 2.530 to 2.535, more preferably from 2.531 to 2.535 and/or any other suitable combination range.

Preferentially, in the material of formula (I) with A=Na, when 1.8≤x≤2.3, the c/a ratio varies from 2.520 to 2.545 when described with an hexagonal unit-cell. Preferentially, in the material of formula (I), when x=2, the c/a ratio varies from 2.520 to 2.540 when described with an hexagonal unit-cell.

The material of formula (I) with A=Na may be described using a rhombohedral (R-3c) structure, wherein sodium ions are located in two sodium sites, Na(1) and Na(2). The site Na(1) is 6-coordinated and sandwiched between 2 VO₆ octahedra along c_{hexagonal}. The site Na(2) is 8-coordinated and occupies the interstitials formed by the M₂(PO₄)₃ units.

Preferably, the material of formula (I) is described in a rhombohedral (R-3c) crystallographic structure with two kinds of sodium sites, Na(1) and Na(2), the average filling rate of the Na(1) sites being from 0 to 1, and the average filling rate of the Na(2) sites being from 0 to 1. By filling rates, it is meant the occupancy of the Na(1) and Na(2) sites over the unit-cell. By filling rates, it is meant the number of occupied sites vs. the number of available sites. It is noted that the multiplicity of the Na(2) site is equal to three times the multiplicity of the Na(1) site and therefore the maximum sodium per formula (I) is equal to 1 on the Na(1) positions and to 3 on the Na(2) positions.

Preferably, the average filling rate of the Na(1) sites varies from 0.2 to 0.95, preferably from 0.3 to 0.9, more preferably from 0.5 to 0.8, even more preferably from 0.6 to 0.7, advantageously is substantially equal to 0.66.

Preferably, the average filling rate of the Na(2) sites varies from 0 to 0.9, preferably from 0.4 to 0.9, more preferably from 0.45 to 0.7, even more preferably from 0.5 to 0.6, advantageously is substantially equal to 0.54.

The present invention also relates to a method of preparation of the material of formula (I), comprising the following steps:
a) mixing A₃V_{(2-α)}Z_{α}(PO₄)₃ and A₁V_{(2-β)}Z′_{β}(PO₄)₃, preferably under inert atmosphere, to obtain an initial mixture,
wherein
A is Li or Na or a mixture of Na and Li,
Z and Z′ are elements independently selected from electro-active transition elements, non electro-active elements and mixtures thereof,
0≤α<1 and 0≤β<1,
b) heating the initial mixture at a temperature between 300° C. and 700° C., preferably under inert atmosphere or under vacuum.

Preferably, in the initial mixture, the molar fraction of Na₃V_{(2-w)}M′_{w}(PO₄)₃ is p and the molar fraction of Na₁V_{(2-z)}M″_{z}(PO₄)₃ is (1-p), with 0<p<1. More preferably, p varies from 0.05 to 0.95, preferably from 0.1 to 0.9, preferably from 0.15 to 0.85, preferably from 0.2 to 0.8, preferably from 0.25 to 0.75, preferably from 0.3 to 0.7, preferably from 0.35 to 0.65, preferably from 0.4 to 0.6, preferably from 0.45 to 0.55, and/or any other suitable combination range.

This process is a solid-solution process. The molar fraction of A₃V_{(2-α)}Z_{α}(PO₄)₃ and A₁V_{(2-β)}Z′_{β}(PO₄)₃ in the initial mixture determine the x value of the product
AₓV_{(2-y-z)}M_{y}M′_{z}(PO₄)₃, with the relation x=1+2p.

Preferably, the electro-active transition element is Ti, V, Cr, Mn, Fe, Co, Ni, Cu, Nb or Mo, more preferably is Ti, V, Cr, Mn, Fe or Nb.

Preferably, the non electro-active element is Mg, Al, Sc, Y, Zr, Er, or Ta, more preferably is Mg, Al or Zr.

Preferably, the method comprises a step a′) between steps a) and b) of pelletizing the initial mixture of step a), preferably under inert atmosphere, to obtain pellets.

The use of pellets gives better contact between particles of A₃V_{(2-α)}Z_{α}(PO₄)₃ and
A₁V_{(2-β)}Z′_{β}(PO₄)₃, and is thus beneficial for the efficiency of step b).

Preferably, during step b), the initial mixture (or the pellets) is (are) heated at a temperature between 400° C. and 600° C., more preferably between 500° C. and 550° C.

Preferably, the method further comprises an initial step, before step a), of preparation of A₁V_{(2-β)}Z′_{β}(PO₄)₃, preferably by chemical oxidation of A₃V_{(2-α)}Z_{α}(PO₄)₃.

Preferably, the method further comprises a step c) of cooling the heated initial mixture (or pellets) obtained at the end of step b) to a temperature comprised between 20 and 40° C.

According to the invention, an inert atmosphere can be an atmosphere comprising N₂ and/or Ar, and less than 2 ppm of O₂ and/or less than 2 ppm of H₂O.

According to another embodiment, Z and Z′ are identical.

According to another preferred embodiment, Z is an electro-active transition element or a mixture of at least two electro-active transition elements and Z′ is a non electro-active element or a mixture of at least two non electro-active elements, or

Z is a non electro-active element or a mixture of at least two non electro-active elements and Z′ is an electro-active transition element or a mixture of at least two electro-active transition elements. In other words, either Z corresponds to M and Z′ corresponds to M′, or Z corresponds to M′ and Z′ corresponds to M of the material of formula (I).

Preferably, α=0 and/or β=0.

The present invention also relates to a method of preparation of the material of formula (I), comprising the following steps:
1) dispersing A₃V_{(2-y-z)}M_{y}M′_{z}(PO₄)₃ in an solvent, preferably an organic solvent,
wherein
A is Na or Li or a mixture of Na and Li,

$$\begin{matrix}0 \leq y < 1 , \\ 0 \leq z < 1 ,\end{matrix}$$

M is an electro-active transition element or a mixture of at least two electro-active transition elements,
M′ is a non electro-active element or a mixture of at least two non electro-active elements,
2) adding an oxidizing agent in the dispersion of A₃V_{(2-y-z)}M_{y}M′_{z}(PO₄)₃,
3) stirring the obtained mixture, and
4) obtaining A₃V_{(2-y-z)}M_{y}M′_{z}(PO₄)₃, with 1<x<3.

M, M′, y and z are as defined above for the material of formula (I) according to the invention.

Preferably, y=0 and/or z=0.

The molar ratio between the quantity of oxidizing agent and the quantity of

A₃V_{(2-y-z)}M_{y}M′_{z}(PO₄)₃ is n. Preferably, 0<n<2. More preferably, n varies from 0.1 to 1.9, preferably from 0.2 to 1.8, preferably from 0.3 to 1.7, preferably from 0.4 to 1.6, preferably from 0.5 to 1.5, preferably from 0.6 to 1.4, preferably from 0.7 to 1.3, preferably from 0.8 to 1.2, preferably from 0.9 to 1.1, and/or any other suitable combination range.

The amount of oxidizing agent added in the dispersion of A₃V_{(2-y-z)}M_{y}M′_{z}(PO₄)₃ determines the value of x in the product A₃V_{(2-y-z)}M_{y}M′_{z}(PO₄)₃, following the relation: x=3−n.

Preferably, the oxidizing agent is added dropwise in the dispersion of

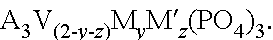

Preferably, the oxidizing agent is selected from the group consisting of NO₂BF₄, Na₂S₂O₈, I₂ and CHCl₃. Advantageously, the oxidizing agent is NO₂BF₄.

The present invention also relates to the use of the material of formula (I) of the invention, as an electrode active material for a battery, preferably as a positive electrode active material for a Li-ion or Na-ion battery, more preferably for a Na-ion battery.

The material of formula (I) may be used together with one or more additional compounds conventionally used, for instance a binder and/or a conductive additive.

Said electron-conducting additive(s) may be chosen from carbon fibers, carbon black, carbon nanotubes, graphite and analogs thereof.

The binder(s) may be advantageously chosen from fluorinated binders, in particular from polytetrafluoroethylene and polyvinylidene fluoride, carboxymethylcellulose-derived polymers, polysaccharides and latexes, in particular of styrene-butadiene rubber type.

The present invention also relates to an electrode for a battery, preferably for a Li-ion or Na-ion battery, more preferably for a Na-ion battery, comprising at least one material of formula (I) according to the invention.

An electrode according to the invention may be a positive electrode of a lithium generator or sodium generator.

Advantageously, the electrode according to the invention is a positive electrode for a secondary sodium or sodium-ion battery.

The electrode may be deposited on an electron-conducting current collector. This collector may be aluminum.

Preferably, the material of formula (I) represents from 10% to 95% by weight of the total weight of the electrode, in particular more than 40% by weight, and more particularly from 80% to 95% by weight relative to the total weight of said electrode.

The present invention also relates to a battery, preferably a Li-ion or a Na-ion battery, more preferably for a Na-ion battery, comprising at least one material of formula (I) of the invention as an electrode active material, preferably as a positive electrode active material.

A secondary sodium battery according to the invention may more particularly comprise a positive electrode according to the invention and a negative electrode consisting for example of disordered carbon. It may, contrary to a secondary lithium battery, be deposited on an aluminum collector given the fact that sodium ions do not react with aluminum to form an alloy, unlike lithium ions.

The material of the negative electrode may more particularly be a disordered carbon with a low specific surface area (<10 m²/g), the particle size of which is about one micrometer to about ten micrometers. It may be chosen from hard carbons (non-graphitizable carbon) or soft carbons (graphitizable carbon).

In the text, the expressions “between . . . and . . . ” and “ranging from . . . to . . . ” and “varying from . . . to . . . ” are equivalent and are intended to mean that the limits are included, unless otherwise mentioned.

### FIGURES

FIG. 1 represents in situ Synchrotron X-Ray Powder Diffraction patterns recorded every 3° C. when a Na₃V₂(PO₄)₃/Na₁V₂(PO₄)₃ mixture (molar ratio of 1:1) is heated up to 500° C. then cooled down to 35° C.

FIG. 2 is a series of XRD patterns of several Na₃V₂(PO₄)₃ and Na₁V₂(PO₄)₃ mixtures before thermal treatment measured at 25° C. (left) and a series of XRD patterns of NaₓV₂(PO₄)₃ single phases measured at 25° C. after a thermal treatment up to 500-550° C. (right).

FIG. 3 are graphics representing the evolution of V/Z (right) and da (left) ratios of NaₓV₂(PO₄)₃ phases refined by the full pattern matching as a function of x, of conventional Na₃V₂(PO₄)₃ and Na₁V₂(PO₄)₃, and of electrochemically observed Na₂V₂(PO₄)₃.

FIG. 4 is XRD patterns of a material of formula (I) according to the invention with x=2 (top), and an electrochemically observed Na₂V₂(PO₄)₃ collected with in situ cell during cycling (bottom).

FIG. 5 is a schematic view of the crystal structure of a material of formula (I) with x=2 according to the invention (left) and of an electrochemically observed Na₂V₂(PO₄)₃ (right).

FIG. 6 is a graphic representing the voltage (V vs. Na⁺/Na) as a function of the specific capacity (mAh/g) of NaₓV₂(PO₄)₃ with x=2 (according to the invention)/Na metal half-cell for the first two cycles (left) and the specific discharge capacity as function of the number of cycle (right)

FIG. 7 is operando XRD patterns of Na₂V₂(PO₄)₃ according to the invention as positive electrode material in a half cell versus Na metal upon charge and discharge, with a voltage window of (a) 2.5-4.4 V and (b) 1.3-3.0 V vs. Na⁺/Na at a C-rate of 0.1 C (≈1 Na⁺ in 10 h).

FIG. 8 are graphics representing the evolution of (a) unit cell volume per formula unit (V/Z), (b) c/a ratio, (c) the total number of Na⁺ per formula unit, and (d) Na occupancy factors of Na1 and Na2 sites, as a function of scan number.

FIG. 9 is a representation of operando XRD measurements using the conventional Na₃V₂(PO₄)₃ as a positive electrode material in a half cell versus Na metal upon charge and discharge, with a voltage window of (a) 2.5-4.3 V vs. Na⁺/Na at a C-rate of 0.1 C (≈1 Na⁺ in 10 h).

The present invention is illustrated in more details in the examples below, but it is not limited to said examples.

### EXAMPLES

### Example 1: Preparation of a material of formula (I)

1.1. The material of formula (I) can be prepared from a mixture of Na₃V₂(PO₄)₃ and Na₁V₂(PO₄)₃.

Synthesis of Na₃V₂(PO₄)₃

The synthesis of Na₃V₂(PO₄)₃ can be performed in two steps. First, carbon-coated VPO₄ was synthesized by mixing stoichiometric amounts of V₂O₅ (Alfa Aesar, 99,6%), H₃PO₄ (Alfa Aesar, 85% in water), and agar-agar (Fisher BioReagents) in deionized water. The solution was stirred overnight at 80° C. in an oil bath before being dried overnight in oven at 250° C. The obtained dried powder was ground and placed in a furnace at 890° C. for 2 h with a heating ramp of 5° C./min in Ar atmosphere. Then, Na₃PO₄ (Acros organics, 96%) was mixed with the resulting VPO₄ in a molar ratio of 1:2, and then heated at 800° C. for 2 h with a heating ramp of 5° C./min in Ar atmosphere.

Synthesis of Na₁V₂(PO₄)₃

To prepare Na₁V₂(PO₄)₃, chemical oxidation of Na₃V₂(PO₄)₃ was performed. Na₃V₂(PO₄)₃ was dispersed in acetonitrile (Sigma-Aldrich, 99.8%) using a magnetic stirrer and an oxidizing agent, nitronium tetrafluoroborate (NO₂BF₄, Sigma-Aldrich, 95%), with 0.1 M solution in acetonitrile was introduced dropwise into the dispersed Na₃V₂(PO₄)₃, to have the following reaction.

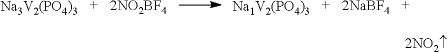

The resulting solution was stirring overnight then filtered and washed with acetonitrile.

Synthesis of NaₓV₂(PO₄)₃

NaₓV₂(PO₄)₃ can be obtained according to the following chemical reaction:

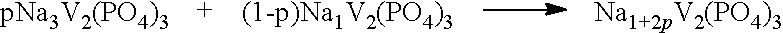

The desired molar ratio of Na₃V₂(PO₄)₃ and Na₁V₂(PO₄)₃ powder was thoroughly mixed, preferably pelletized, in an Ar-filled glove box. Then the resulting powder was sealed with a gold tube prior to a heat-treatment at 500° C. for 12 h.

1.2. A material of formula (I) according to the invention can be also prepared by controlling oxidizing agent during the chemical oxidation process of Na₃V₂(PO₄)₃ instead of mixing the two materials (Na₁V₂(PO₄)₃ and Na₃V₂(PO₄)₃) with different ratios.

Na₃V₂(PO₄)₃ was dispersed in acetonitrile (Sigma-Aldrich, 99.8%) using a magnetic stirrer and desired amount of 0.1 M solution of nitronium tetrafluoroborate (NO₂BF₄, Sigma-Aldrich, 95%) in acetonitrile was introduced dropwise into the dispersed Na₃V₂(PO₄)₃ to have the following reaction.

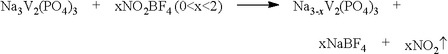

The resulting solution was stirring overnight then filtered and washed with acetonitrile.

The same considerations apply to materials of general formula AₓV_{2-y-z}M_{y}M′_{z}(PO₄)₃ that can intercalate or liberate Na⁺ according to two-phase of single phase processes at operating voltages that depend on the nature of the redox couples associated to the reduction or oxidation of V and/or M (refs. 1-6). It is well known for instance that Na₁Ti₂(PO₄)₃ and Na₃Ti₂(PO₄)₃ exist (y=2), and can be prepared by chemical oxidation or reduction of one of the two to the other or by electrochemical Na⁺ insertion or extraction. The same applies for Na₃AlV(PO₄)₃ and Na₁AlV (PO₄)₃ (y=0, z=1), for NbTi(PO₄)₃ and Na₂NbTi(PO₄)₃ (y=2), for Na₃FeV(PO₄)₃ and Na₁FeV(PO₄)₃ (y=1). These end members can be isolated and mixed and heated to produce new NaₓV_{2-y-z}M_{y}M′_{z}(PO₄)₃ single-phase materials.
(1) Masquelier, C.; Croguennec, L. Polyanionic (phosphates, silicates, sulphates, . . . ) frameworks as electrode materials for rechargeable Li (or Na) batteries, Chem. Rev., 113(8), 6552-6591 (2013)
(2) F. Lalere, V. Seznec, M. Courty, J. N. Chotard & C. Masquelier, Improving the energy density of Na₃V₂(PO₄)₃—type positive electrodes through V/Al substitution, J. Mater. Chem. A, 3, pp. 16198-16205 (2015)
(3) Aragón, M. J.; Lavela, P.; Alcántara, R.; Tirado, J. L. Effect of Aluminum Doping on Carbon Loaded Na₃V₂(PO₄)₃ as Cathode Material for Sodium-Ion Batteries. Electrochim. Acta 2015, 180, 824-830. https://doi.org/10.1016/j.electacta.2015.09.044
(4) Liang, L.; Li, X.; Zhao, F.; Zhang, J.; Liu, Y.; Hou, L.; Yuan, C. Construction and Operating Mechanism of High-Rate Mo-Doped Na₃V₂(PO₄)₃@C Nanowires toward Practicable Wide-Temperature-Tolerance Na-Ion and Hybrid Li/Na-Ion Batteries. Adv. Energy Mater. 2021, 11 (21), 1-17. https://doi.org/10.1002/aenm.202100287.
(5) Liu, X.; Feng, G.; Wang, E.; Chen, H.; Wu, Z.; Xiang, W.; Zhong, Y.; Chen, Y.; Guo, X.; Zhong, B. Insight into Preparation of Fe-Doped Na₃V₂(PO₄)₃ @ C from Aspects of Particle Morphology Design, Crystal Structure Modulation, and Carbon Graphitization Regulation. ACS Appl. Mater. Interfaces 2019, 11, 12421-12430.
   https://doi.org/10.1021/acsami.8b21257.
(6) Zakharkin, M. V.; Drozhzhin, O. A.; Ryazantsev, S. V.; Chernyshov, D.; Kirsanova, M. A.; Mikheev, I. V.; Pazhetnov, E. M.; Antipov, E. V.; Stevenson, K. J.; Antipov, V.; Stevenson, K. J. Electrochemical Properties and Evolution of the Phase Transformation Behavior in the NASICON-Type Na₃₊ₓMnₓV₂₋ₓ(PO₄)₃ (0≤x≤1) Cathodes for Na-Ion Batteries. J. Power Sources 2020, 470 (February), 228231.
   https://doi.org/10.1016/j.jpowsour.2020.228231.

### Example 2: In-Situ Monitoring of the Formation of the Material of Formula (I)

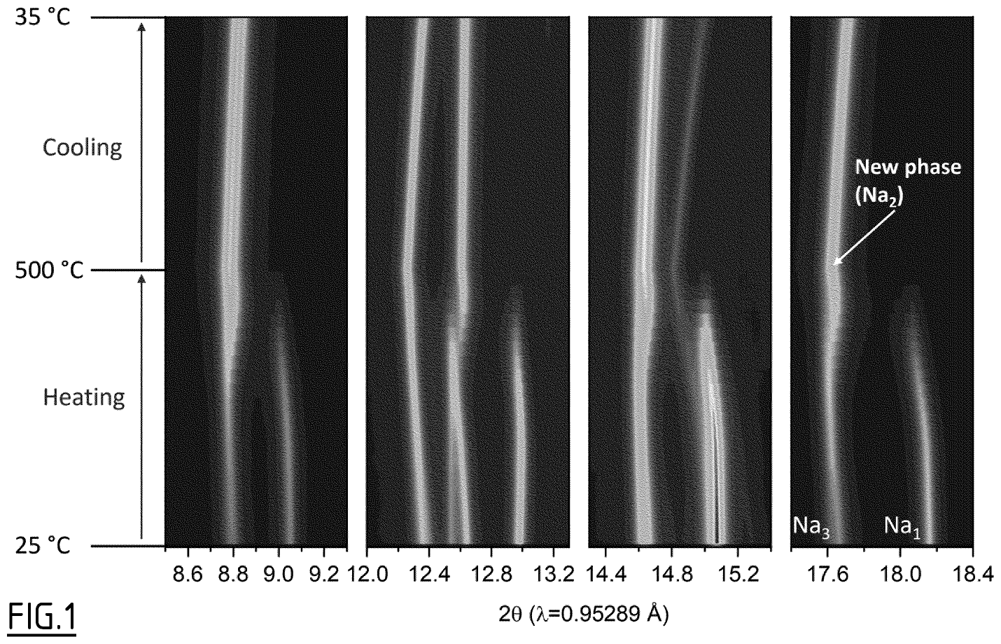

The reaction between Na₃V₂(PO₄)₃ and Na₁V₂(PO₄)₃ of example 1.1 was monitored by in situ temperature-controlled synchrotron XRD patterns as shown in FIG. 1. Data were collected in Debye-Scherrer geometry, at a wavelength of 0.9529 Å, using a 0.5 mm diameter capillary. The XRD patterns were collected every 3° C. while the mixture of Na₃V₂(PO₄)₃ and Na₁V₂(PO₄)₃ by a molar ratio of 1:1 was heated up to 500° C. then cooled down to 35° C. During heating overall XRD reflection peaks of the two phases, Na₃V₂(PO₄)₃ and Na₁V₂(PO₄)₃, shift to lower angle due to mainly thermal expansion. As the temperature was raised to above ˜300° C. the two phases started vanishing with a new single-phase forming concomitantly, and reaction 1 was fully completed at 500° C. During cooling, the XRD reflection peaks of the new single-phase material were maintained without phase separation down to 35° C., having a slight peak shift to a higher angle due to thermal contraction.

### Example 3: Structural Characterization of the Material of Formula (I)

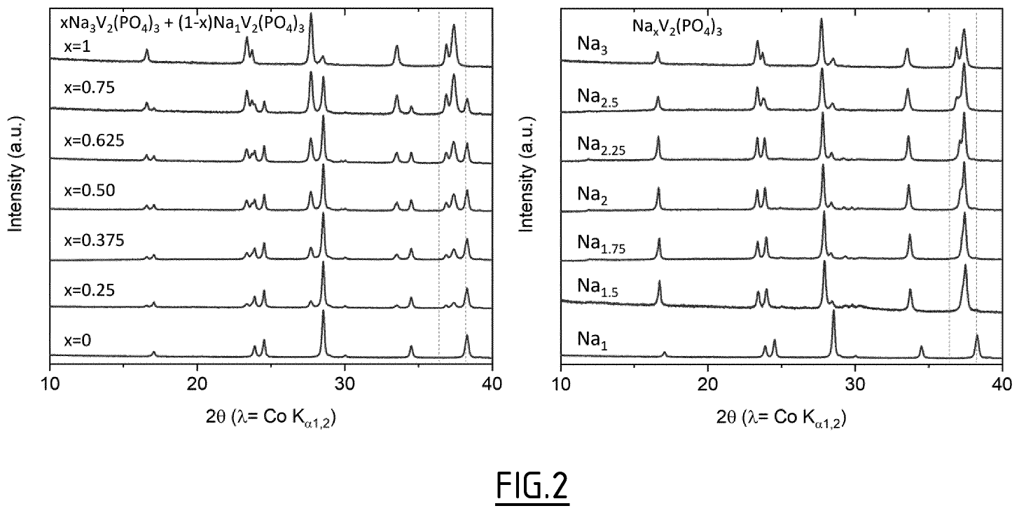

Using the method described in example 1.1, several materials of formula (I) with different compositions were prepared and compared with the two end-members Na₃V₂(PO₄)₃ and Na₁V₂(PO₄)₃ as shown in FIG. 2. Laboratory X-ray diffraction was used in reflection geometry on a PANalytical X'Pert Pro diffractometer at the Co_{Kα1,2} radiation. Before the heat-treatments, the two mixed phases with different ratios of Na₃V₂(PO₄)₃ and Na₁V₂(PO₄)₃ appeared in the XRD patterns. The XRD reflection peaks from the various compositions do not shift but the intensities vary with respect to the different molar ratios shown in FIG. 2a. However, after the thermal heat treatments, the two mixed phases become a single phase. Also, the reflection peaks shift to lower angle as x increases from 1 to 3 in NaₓV₂(PO₄)₃.

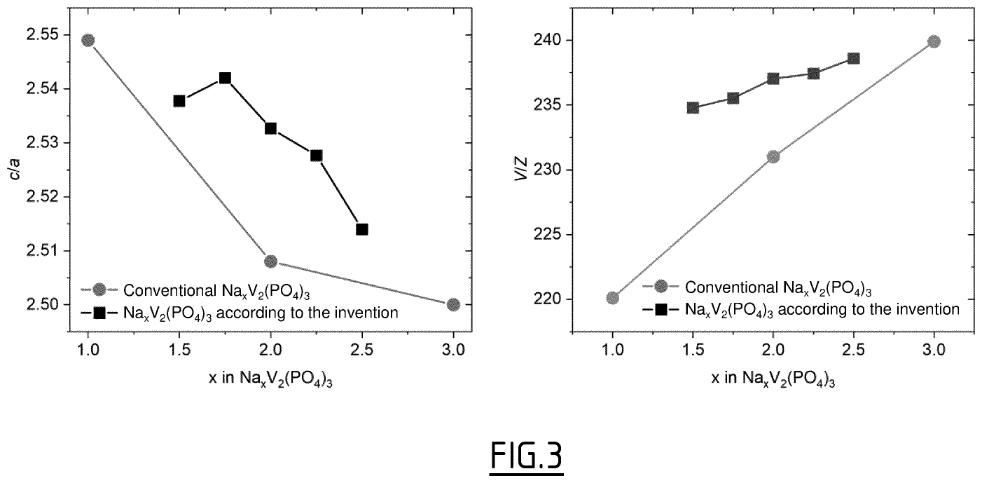

This is further confirmed by the structural analysis using Full pattern matching shown in FIG. 3. Unit cell volumes per formula unit (V/Z) gradually increase while c/a ratios tend to decrease as the number of Na⁺ increases from 1 to 3 in NaₓV₂(PO₄)₃. V/Z and c/a ratios of conventional Na₃V₂(PO₄)₃, Na₂V₂(PO₄)₃ and NaV₂(PO₄)₃ are also represented for comparison purpose.

### Example 4: Comparison Between the Structure of the Material of Formula (I) According to the Invention and an Electrochemically Observed Material Na₂V₂(PO₄)₃

To electrochemically observe the material Na₂V₂(PO₄)₃, Operando synchrotron XRD measurements were performed with Debye-Scherrer geometry (λ=0.8266 Å) using an in situ coin cell with glass windows. Each synchrotron XRD pattern was collected every 30 minutes with an acquisition time of 3.5 minutes in the 2θ angular range of 2-40°, with a 2θ step size of 0.006° using a MYTHEN detector. The working electrodes were composed of the Na₃V₂(PO₄)₃ powder and carbon black (80/20 in weight ratio), and Na metal was used as counter/reference electrode. The assembled coin cells were cycled at 0.77 C in the voltage windows of 2.0-4.3 V vs. Na⁺/Na (1 C=58.2 mA/g, or about 9 h for the exchange of 1Na⁺/1e⁻).

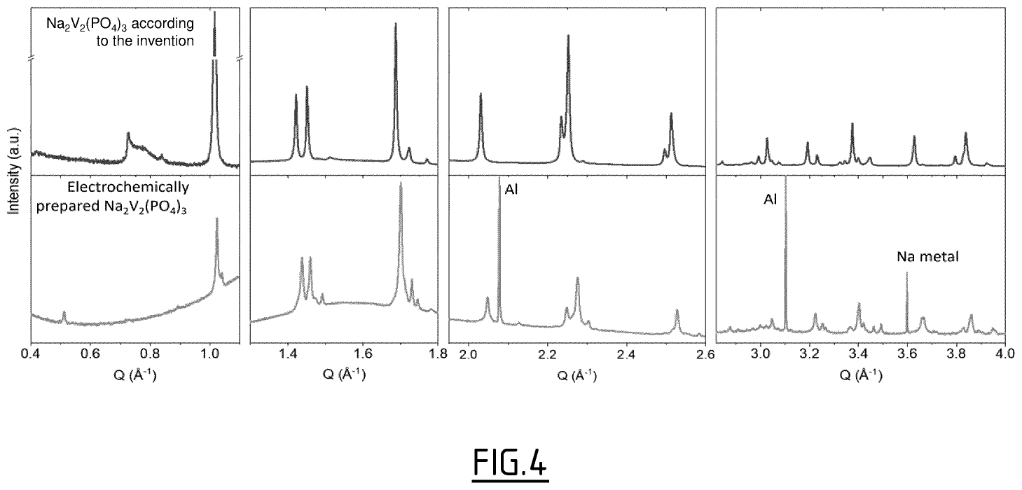

FIG. 4 shows a comparison of the XRD patterns between a material of formula (I) according to the invention with x=2 (collected with a capillary), and an electrochemically observed Na₂V₂(PO₄)₃ collected with in situ cell during cycling according to the above-described procedure. The differences of Bragg peaks at around 0.7 Å⁻¹ clearly manifests that the two structures are different.

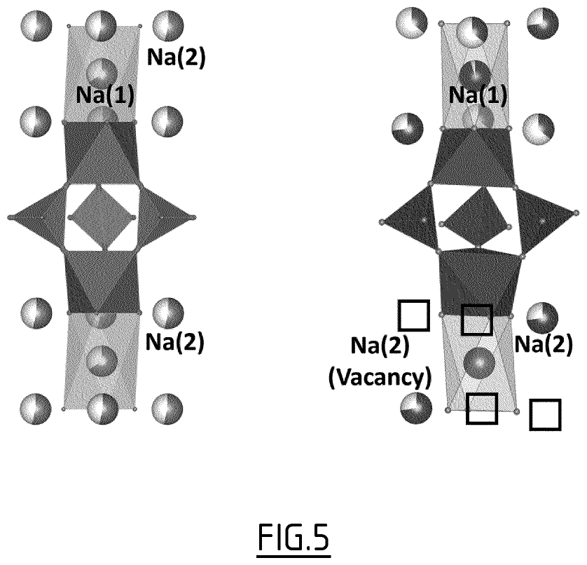

FIG. 5 is a schematic view of a crystal structure of a material of formula (I) according to the invention with x=2 (left) and an electrochemically observed Na₂V₂(PO₄)₃ (right). The clear difference between the two structures is that Na-sites (the sites where Na can be inserted and de-inserted) do not have the same location, and do not have the same occupancy factors.

In the table below are gathered the main parameters defined by the structural analysis using the Rietveld method for the material of formula (I) according to the invention with x=2 and an electrochemically observed Na₂V₂(PO₄)₃.

| | A | C | c/a | V/Z (Å³) | Na(1) | Na(2) |
|---|---|---|---|---|---|---|
| Na₂V₂(PO₄)₃ | 8.6538(2) | 21.8964(6) | 2.530 | 236.684(9) | 0.66(4) | 0.54(3) |
| (according to the | | | | | | |
| invention) | | | | | | |
| Electrochemically | 8.6096(2) | 21.5910(8) | 2.508 | 232.003(13) | 0.98(4) | 0.33(2) |
| observed | | | | | | |
| Na₂V₂(PO₄)₃ | | | | | | |
| (comparative) | | | | | | |

### Example 5: Electrochemical Evaluation of a Material of Formula (I)

The electrochemical performances of the material of formula (I) with x=2 was tested with a half-cell configuration in CR2032-type coin cells. The positive electrodes were composed of the active material of formula (I) with x=2, carbon black, and poly (vinylidene difluoride) with a weight ratio of 73/18/9. The electrodes were dried at least 12 hours at 80° C. under vacuum prior to the cell assembly. For a cell assembly, one sheet of Whatman glass fiber (GF/D) was used as a separator and the electrolyte was composed of 1 M NaPF₆ in ethylene carbonate (EC)/dimethyl carbonate (DMC) (1:1, w/w) with 2 wt. % of fluoroethylene carbonate (FEC). The assembled coin cells were cycled at 0.1 C in the voltage windows of 2.5-4.3 V vs. Na⁺/Na.

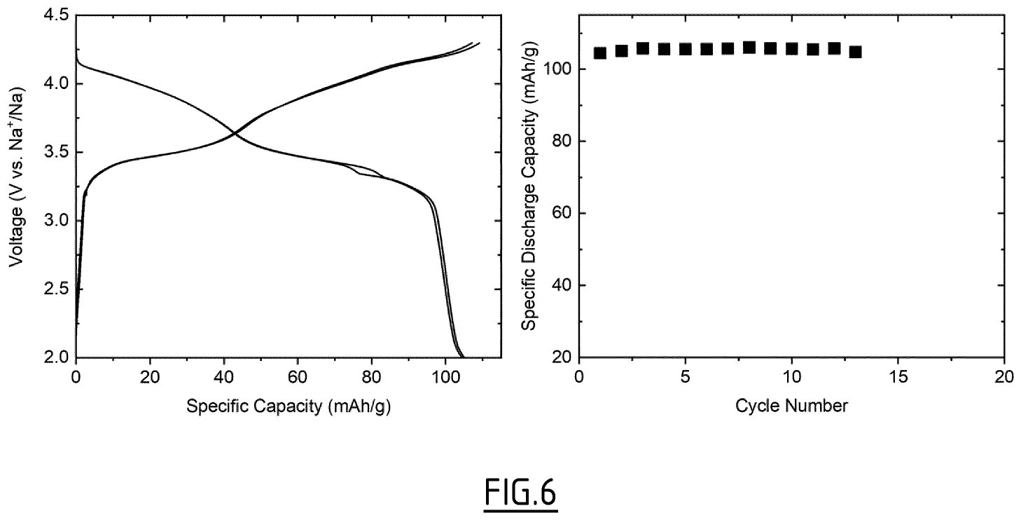

As shown in FIG. 6, the first charge and discharge capacities are 109.3 and 104.4 mAh/g, respectively, with the irreversibility of 4.5%. The voltage profiles of the following cycles are very similar to the first one, indicating that Na⁺ extraction/insertion in Na₂V₂(PO₄)₃ according to the invention is highly reversible.

### Example 6: Structural Evolution of the Material of Formula (I) During Na⁺ Extraction/Insertion

Operando X-ray diffraction measurements were performed using an in situ cell with Beryllium windows with a PANalytical Empyrean diffractometer equipped with Cu_{Kα1,2} radiation. Each XRD pattern was collected every one hour in the 2θ angular range of 12-40°, with a 2θ step size of 0.0167°. The working electrodes were composed of the material of formula (I) Na₂V₂(PO₄)₃ powder and carbon black (80/20 in wt %), and Na metal was used as counter/reference electrode. The same separator and electrolyte as the coin cell tests were used for the operando experiments of example 5. Two different voltage regions were explored: 2.5-4.4 V and 1.3-3.0 V vs. Na⁺/Na, with an electrochemical reaction rate of 0.1 C (10 h for the exchange of 1Na⁺/1e⁻). The analysis of XRD data was performed using the Rietveld method with Fullprof Suite.

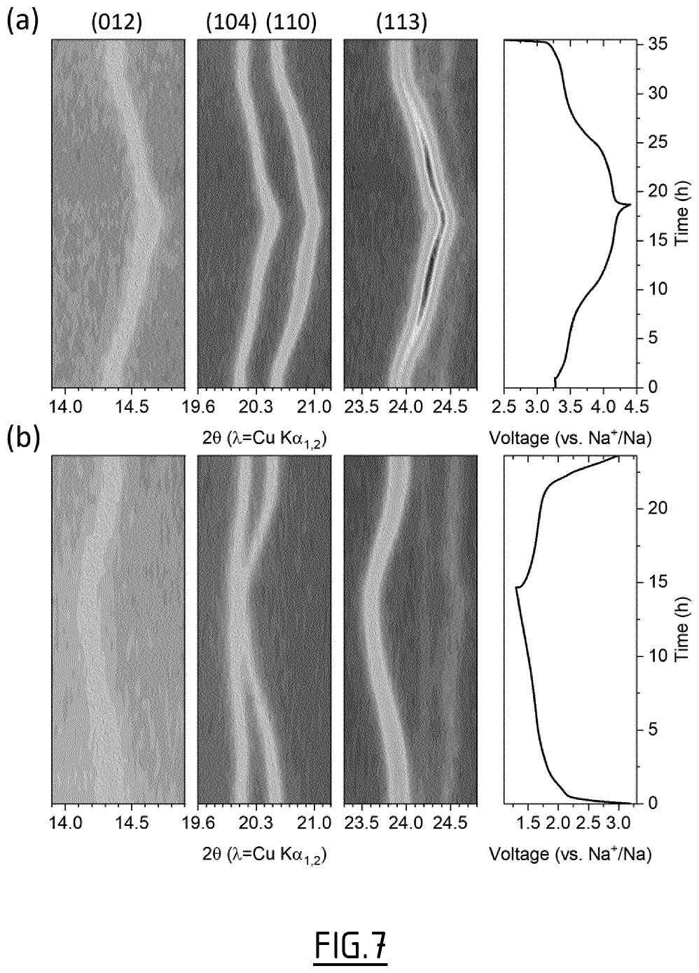

As shown in FIG. 7, the XRD reflection peaks continuously shift during cycling in both voltage windows of 2.5 V-4.4 V and 1.3 V-3.0 V vs. Na⁺/Na, confirming a solid-solution mechanism. The evolutions of the peak shifts during charge and discharge are symmetrical, exhibiting the Na⁺ extraction/insertion mechanism remains unchanged. Also, the XRD pattern of Na₂V₂(PO₄)₃ obtained after the first cycle appears similar to the initial one, meaning that the overall electrochemical reaction is highly reversible.

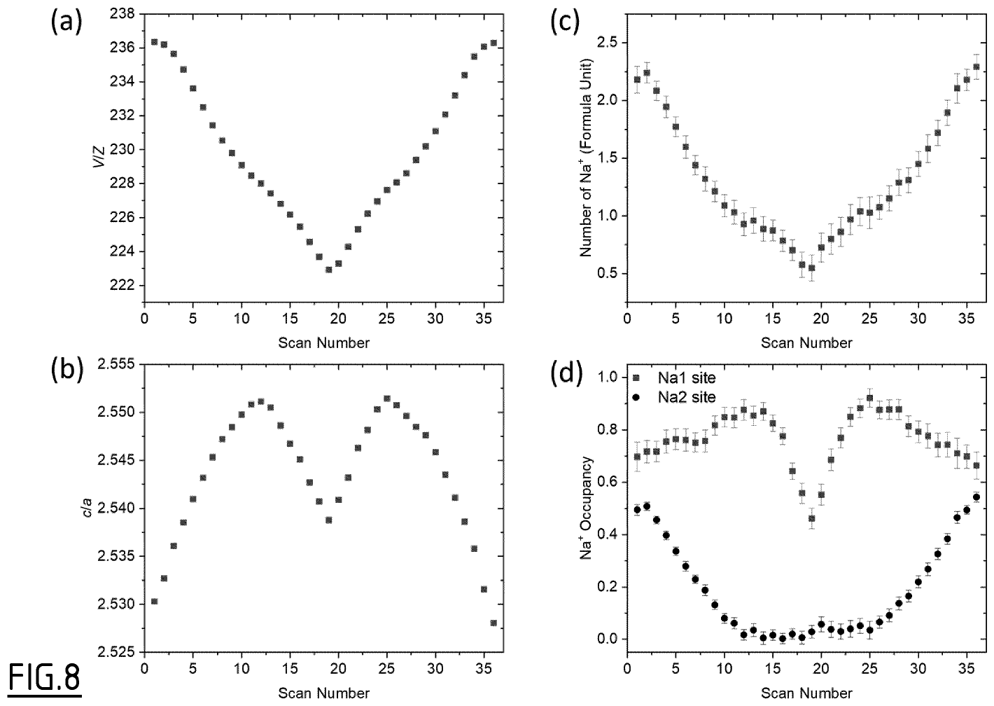

The results of the Rietveld refinements from the operando XRD measurements when cycled between 2.5-4.4 V vs. Na⁺/Na further confirm that the electrochemical reaction during charge and discharge is symmetrical and reversible as shown in FIG. 8. The unit cell volumes of the pristine material of formula (I) and at the end of charge are 236.35(2) Å³ and 222.92(2) Å³, respectively, about 5.7% of volume changes. This is lower than the volume changes of the conventional Na₃V₂(PO₄)₃ (about 8.2%), when the similar number of Na⁺ is involved in the electrochemical reaction. The ratios of c and a parameters increase up to around mid-charge (˜scan number 12) then decrease until the end of charge.

Concerning Na⁺ occupancy, the total number of Nat in the structure gradually decreases during charge and increases during discharge. The main contribution of decreasing number of Na⁺ until mid-charge is due to decreasing occupancy factor of Na(2) site. After that, there is a rapid decrease in the occupancy of Na(1) site until the end of the charge, resulting in a further decrease of total Na⁺ (see FIG. 5 for the localization of the Na1 and Na2 sites in the crystal structure of the material according to the invention).

### Example 7 (Comparative): Electrochemical and Structural Evaluation of the Conventional Na₃V₂(PO₄)₃

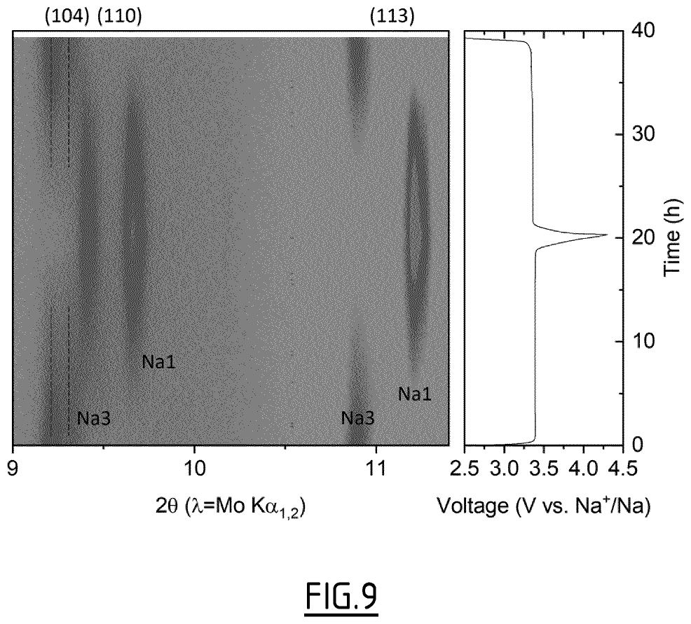

As a comparative example, operando X-ray diffraction measurements using the conventional Na₃V₂(PO₄)₃ electrode with Mo_{Kα1,2} radiation cycled between 2.5 and 4.3 V vs. Na⁺/Na at the same C-rate of 0.1 C (=1 Na⁺ in 10 h). Compared to the material of formula (I) according to the invention, the Na⁺ insertion/extraction mechanism of the conventional Na₃V₂(PO₄)₃ is different and shows a typical characteristic of a two-phase reaction between Na₃V₂(PO₄)₃ and Na₁V₂(PO₄)₃: during charge, Na₃V₂(PO₄)₃ phase is diminishing while Na₁V₂(PO₄)₃ is appearing, and during discharge, the phase appearance/disappearance occurs in an opposite manner. This phenomenon is visible in FIG. 9: the diffraction peaks corresponding (104), (110), and (113) reflections from the two end-members, Na₁V₂(PO₄)₃ and Na₃V₂(PO₄)₃ clearly manifest the two-phase mechanism, unlike the material of formula (I) of the invention.

The cell volumes of Na₃V₂(PO₄)₃ and Na₁V₂(PO₄)₃ are 239.903(17) Å³ and 220.105(8) Å³, respectively, and the volume changes are about 8.2%, as summarized in the table below.

| | a | c | c/a | V/Z (Å³) |
|---|---|---|---|---|
| Na₃V₂(PO₄)₃ | 8.7277(3) | 21.8199(12) | 2.500(2) | 239.903(17) |
| Na₁V₂(PO₄)₃ | 8.4263(2) | 21.4772(6) | 2.549(2) | 220.105(8) |

What is claimed is:

1. A material of formula (I): 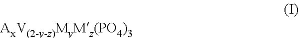
wherein:
A is Na or Li or a mixture of Na and Li,
$$\begin{matrix}1 < x < 3 , \\ 0 \leq y \leq 1 , \\ 0 \leq z \leq 1\end{matrix}$$
M is an electro-active transition element or a mixture of at least two electro-active transition elements,
M′ is a non electro-active element or a mixture of at least two non electro-active elements, and
the material of formula (I) presents a V/Z ratio varying from 212 Å³ to 246 Å³,
with the proviso that, if x=2, the V/Z ratio varies from 232 Å³ to 239 Å³.

2. The material according to claim 1, wherein A=Li and the V/Z ratio varies from 212 Å³ to 225 Å³.

3. The material according to claim 1, wherein A=Na and the V/Z ratio varies from 219 Å³ to 246 Å³.

4. The material according to claim 3, with the proviso that if x=2, the V/Z ratio from 235 Å³ to 238 Å³.

5. The material according to claim 1, wherein x varies from 1.5 to 2.5.

6. The material according to claim 3, wherein the V/Z ratio varies from 234 Å³ to 239 Å³.

7. The material according to claim 3, described with a hexagonal unit-cell and presenting lattice parameters a and c, wherein the c/a ratio varies from 2.510 to 2.545.

8. The material according claim 3, described using a rhombohedral (R-3c) crystallographic structure with two kinds of sodium sites, Na(1) and Na(2), the average filling rate of the Na(1) sites being from 0.2 to 0.95 over the unit cell, and the average filling rate of the Na(2) sites being from 0 to 0.9 over the unit cell.

9. The material according to claim 1, being a single-phase material.

10. A method of preparation of the material of formula (I) according claim 1, comprising the following steps:
a) mixing A₃V_{(2-α)}Z_{α}(PO₄)₃ and A₁V_{(2-β)}Z′_{β}(PO₄)₃, preferably under inert atmosphere, to obtain an initial mixture, wherein
A=Li or Na or a mixture of Na and Li,
Z and Z′ are metal elements independently selected from electro-active transition elements, non electro-active elements and mixtures thereof, and
0≤α<1 and 0≤β<1,
b) heating the initial mixture at a temperature between 300° C. and 700° C., preferably under inert atmosphere or under vacuum.

11. The method according to claim 10, wherein, in the initial mixture, the molar fraction of Na₃V_{(2-w)}M′_{w}(PO₄)₃ is p and the molar fraction of Na₁V_{(2-z)}M″_{z}(PO₄)₃ is (1-p), with 0 <p<1.

12. A method of preparation of the material of formula (I) according to claim 1, comprising the following steps:
1) dispersing A₃V_{(2-y-z)}M_{y}M′_{z}(PO₄)₃ in an solvent, preferably an organic solvent, wherein
A is Na or Li or a mixture of Na and Li,
$$\begin{matrix}0 \leq y < 1 , \\ 0 \leq z < 1 ,\end{matrix}$$
M is an electro-active transition element or a mixture of at least two electro-active transition elements,
M′ is a non electro-active element or a mixture of at least two non electro-active elements,
2) adding an oxidizing agent in the dispersion of A₃V_{(2-y-z)}M_{y}M′_{z}(PO₄)₃,
3) stirring the obtained mixture, and
4) obtaining AₓV_{(2-y-z)}M_{y}M′_{z}(PO₄)₃, with 1<x<3.

13. Use of the material of formula (I) as defined in claim 1, as an electrode active material for a battery, preferably as a positive electrode active material for a Li-ion or Na-ion battery, more preferably for a Na-ion battery.

14. An electrode for a battery, preferably for a Li-ion or a Na-ion battery, more preferably for a Na-ion battery, comprising at least one material of formula (I) as defined in claim 1.

15. A battery, preferably a Li-ion or a Na-ion battery, more preferably a Na-ion battery, comprising at least one material of formula (I) as defined in claim 1 as an electrode active material, preferably as a positive electrode active material.
